(19) United States
(12) Patent Application Publication
(10) Pub. No.: US 2002/0092476 A1
(43) Pub. Date: Jul. 18, 2002

(54) Animal feeder

(76) Inventors: Bonnie L. Vlach, Walton Hills, OH (US); Dan J. Kossin, Fairview Park, OH (US)

Correspondence Address: Jason A. Worgull, Esq., Fay, Sharpe, Fagan, Minnich & McKee, LLP, 1100 Superior Avenue, 7th Floor, Cleveland, OH, 44114-2518, US

(21) Appl. No.: 10/051,586

(22) Filed: Jan. 17, 2002

Related U.S. Application Data
(60) Provisional application No. 60/262,528, filed on Jan. 18, 2001.

(51) Int. Cl. A01K 1/10; A01K 5/00; A01K 39/00

(52) U.S. Cl. 119/61

(57) ABSTRACT

An animal feeder assembly includes a semi-cylindrical feed trough, which defines a plurality of drainage apertures, and a pair of semi-circular end caps. A pair of horizontal cross members are connected and disposed substantially perpendicular to an underside of the feed trough adjacent the end caps. A pair of height-adjustable support legs are connected to opposing ends of each horizontal cross member such that the support legs form an angle of between 45° and 60° with the ground. The animal feeder assembly is made from a weather-resistant material, preferably polyvinyl chloride. The animal feeder assembly provides a durable, height-adjustable feeding device, which is versatile and well-suited for use with animals ranging in size from medium-sized dogs to larger animals, including deer and horses.

### CROSS-REFERENCE TO RELATED PROVISIONAL PATENT APPLICATION

This application claims the benefit under 35 U.S.C. §119(e) of U.S. Provisional Application No. 60/262,528, filed Jan. 18, 2001.

### BACKGROUND OF THE INVENTION

The present invention relates generally to animal feeding devices, and more particularly to a weather-resistant, outdoor wildlife feeder for feeding deer, horses, and other livestock. However, it is to be appreciated that the present invention will also find application in an animal feeder suitable for feeding domestic animals, such as large dogs.

Many individuals enjoy watching various wildlife, such as deer, in their natural environment. To this end, individuals provide wildlife feed, such as corn, grains, and the like, on their property for the benefit of wildlife. Conventional wildlife feeding devices include rectangular feed bins or troughs, generally constructed out of wood. Such feeders tend to develop splinters and contain sharp corners, both of which are hazardous to animals that are feeding. Rectangular, flat-bottomed troughs also include corners, which limit wildlife access to feed contained therein. In addition, wood feeders deteriorate and rot as a result of prolonged exposure to adverse weather conditions.

Some conventional feeding devices include metal mesh or screening in the bottom of the trough or bin portion, which facilitates drainage of excess water. However, in cold weather conditions, metal mesh is not safe for feeding animals.

In addition, it is well known by animal professionals that the health of large dogs may be adversely affected if such dogs are fed from a container positioned at floor level. More particularly, eating from an elevated position aids in digestion and reduces joint problems, such as arthritis, in dogs.

Accordingly, the present invention contemplates a new and improved animal feeder, which overcomes the above-referenced problems and others.

### SUMMARY OF THE INVENTION

In accordance with one aspect of the present invention, an animal feeder assembly includes a semi-cylindrical feed trough having a pair of semi-circular end caps connected thereto. A pair of horizontal cross members are connected to an underside of the feed trough adjacent the end caps. The cross members are disposed substantially perpendicular to the feed trough. A pair of height-adjustable support legs are connected to opposing ends of each horizontal cross member, such that the support legs form an angle of between 45° and 60° with the ground.

In accordance with a more limited aspect of the present invention, the semi-cylindrical feed trough is made from polyvinyl chloride.

In accordance with a more limited aspect of the present invention, the semi-cylindrical feed trough defines a plurality of regularly spaced drainage apertures.

In accordance with a more limited aspect of the present invention, each height-adjustable support leg includes an upper portion, a lower portion, and securing means for setting the support leg at a desired height. The upper portion includes a first end connected to the corresponding horizontal cross member and a second end adapted to receive the lower portion. The lower portion includes a first end slidably connected to the second end of the upper portion and a second end adapted to engage the ground. The second end includes an inclined surface having an angle which is complimentary to the angle between 45° and 60°.

In accordance with a more limited aspect of the present invention, each height-adjustable support leg includes an upper portion and a lower portion threadably attached thereto. The upper portion includes a first end connected to the corresponding horizontal cross member and a second threaded end adapted to receive the lower portion. The lower portion includes a first end threadably connected to the second end of the upper portion and a second end adapted to engage the ground.

In accordance with another aspect of the present invention, a wildlife feeder includes a feed trough having a pair of end portions and a curved bottom surface which defines a plurality of drainage apertures. A pair of height-adjustable support structures are connected to an underside of the feed trough adjacent each end portion.

In accordance with a more limited aspect of the present invention, the feed trough is comprised of a semi-cylindrical polyvinyl chloride pipe having a diameter between six inches and ten inches.

In accordance with a more limited aspect of the present invention, each height-adjustable support structure includes a horizontal member disposed substantially perpendicular to the feed trough and a pair of height-adjustable support legs connected to opposing ends of the horizontal cross member. The support legs each include an upper portion, a lower portion, and height adjustment means connected to the upper and lower portions.

In accordance with a more limited aspect of the present invention, the height adjustment means includes a threaded piece connecting the upper and lower portions.

In accordance with a more limited aspect of the present invention, the heigh adjustment means includes an intermediate piece telescopically connected to at least one of the upper and lower portions and a set screw disposed adjacent the intermediate piece.

In accordance with a more limited aspect of the present invention, the support legs are disposed at an angle of between 45° and 60° relative to the ground. Each support leg includes a bottom surface having an angle of between 30° and 45°.

One advantage of the present invention is that it provides easy access to feed for animals of varying sizes.

Another advantage of the present invention is that it is weather resistant.

Yet another advantage of the present invention resides in an animal feeder that is light-weight and easily transportable.

Another advantage of the present invention is that excess water drains away from the feed.

Other benefits and advantages of the present invention will become apparent to those skilled in the art upon a reading and understanding of the preferred embodiment.

### BRIEF DESCRIPTION OF THE DRAWINGS

The invention may take form in various components and arrangements of components, and in various steps and arrangements of steps. The drawings are only for purposes of illustrating preferred embodiments and are not to be construed as limiting the invention.

FIG. 1 is an end elevational view of the animal feeder of the present invention;

FIG. 2 is a side elevational view of the animal feeder of the present invention;

FIG. 3 is a side perspective view of the animal feeder of the present invention;

FIG. 4 is a top plan view of the animal feeder of the present invention; and

FIGS. 5A and 5B are exploded views of a height-adjustable portion of the support legs in accordance with two embodiments of the present invention.

### DETAILED DESCRIPTION OF THE PREFERRED EMBODIMENTS

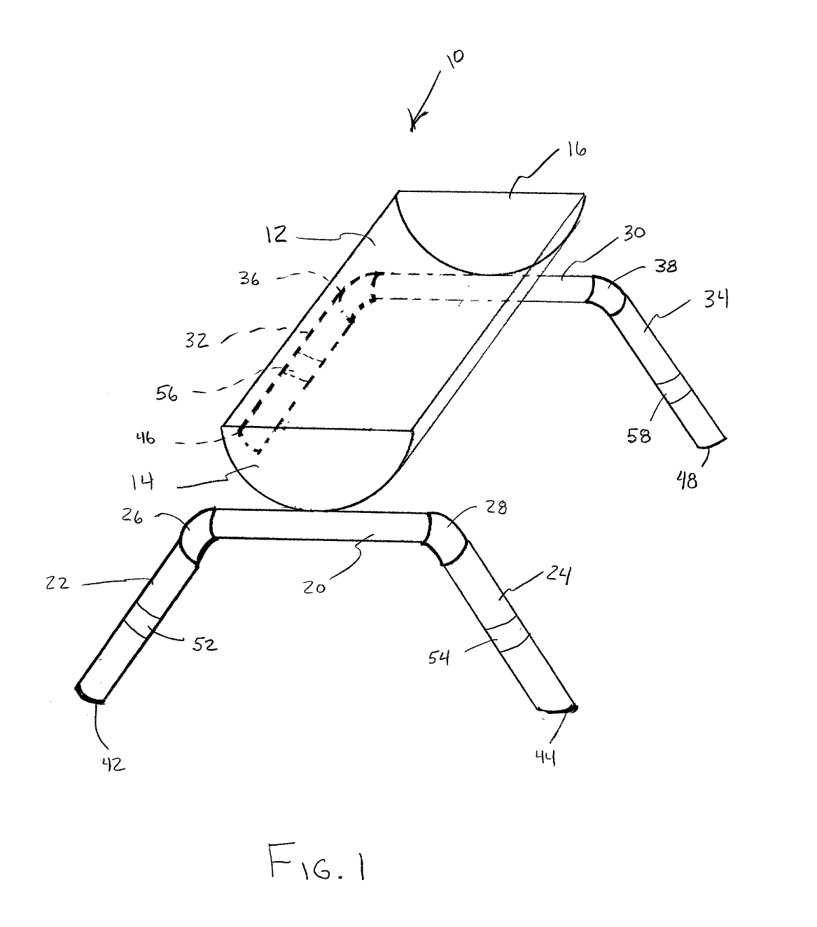

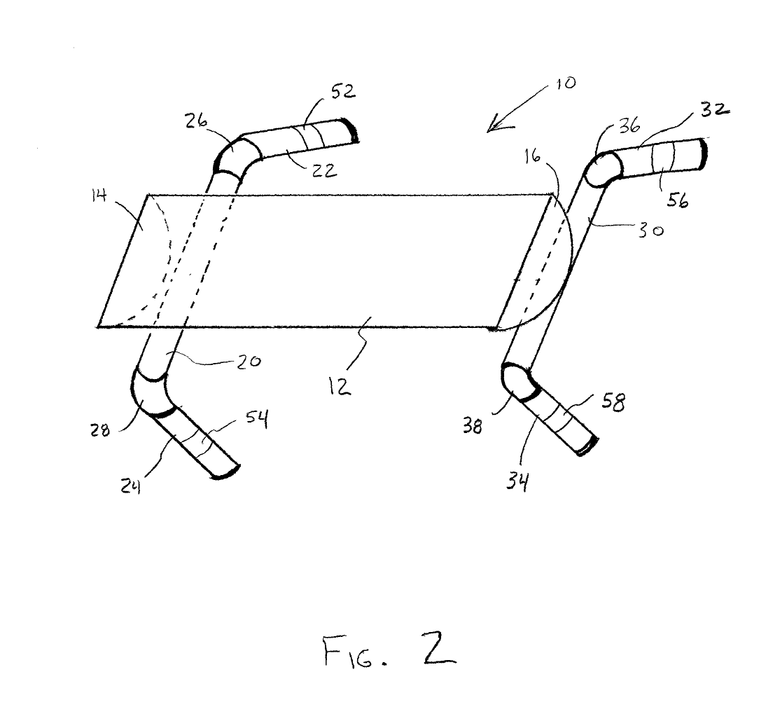

Referring now to the drawings wherein like reference numerals designate identical or corresponding parts throughout the several views, FIGS. 1-4 illustrate an animal feeder assembly 10 according to a preferred embodiment of the present invention. The feeder assembly 10 includes a curved body portion or feed trough 12. Preferably, the feed trough 12 is made from a weather-resistant material and is semi-cylindrical in shape. In one embodiment, the feed trough 12 is formed from Schedule 35 (six inch diameter) or Schedule 40 (eight inch diameter) polyvinyl chloride (PVC) piping. More particularly, a piece of PVC piping of suitable dimensions is cut in half lengthwise, providing the semi-cylindrical feed trough. The PVC piping may assume a variety of diameters and lengths. In another embodiment, the feed trough is made of blow molded plastic. In one embodiment, the feed trough has a diameter of approximately eight inches and a length of approximately four feet. In another embodiment, the feed trough has a diameter of approximately six inches and a length of between two and three feet. However, it is to be appreciated that other diameters and lengths are contempted depending upon the desired application.

In one embodiment, the semi-cylindrical feed trough 12 is closed at both ends by semi-circular end caps 14, 16. The end caps 14, 16 serve to prevent food from spilling out of the sides of the feed trough 12 while an animal is eating. In one embodiment, the end caps 14, 16 are connected to the feed trough 12 by a non-toxic epoxy, such as PVC cement, or other suitable fastening means. Alternatively, fasteners, such as sheet metal screws, are employed.

The feed trough 12 is supported by two horizontal cross members 20, 30 that are oriented substantially perpendicular to the feed trough 12, as shown. Preferably, the horizontal cross members 20, 30 consist of PVC piping having a diameter of between 1.5 inches and 2.0 inches. Each horizontal cross member 20, 30 is connected to two support members or legs 22, 24, 32, 34 via PVC elbow joints 26, 28, 36, 38. In one embodiment, each horizontal cross member is connected to two support members using two 60° elbow joints. It is to be appreciated that elbow joints of other angles, such as 45°, as well as other attachment means may be employed. The horizontal cross members and support members are fastened to the elbow joints using PVC cement or other suitable fastening means.

As illustrated in FIGS. 1, the animal feeder assembly provides maximum stability because of the angle each leg forms with the ground. As described above, in one embodiment, each leg is connected to one of the horizontal cross members such that it is disposed at a 60° angle with the ground. Alternately, each leg may be disposed at a 45° angle relative to the ground. In addition, the ends 42, 44, 46, 48 of each leg 22, 24, 32, 34 are cut at an angle of approximately 30° so as to engage the ground and provide better stability. Alternately, the ends of each leg may be cut at angles greater or less than 30° depending upon the angle between the leg and the ground. In other words, the bottom surface or end of each leg is cut at an angle that is complementary to the angle formed between the leg and the ground. For example, if the leg is disposed at a 50° angle relative to the ground, the bottom surface or end of the leg is cut at a 40° angle. Because the legs are not perpendicular to the ground, the animal feeder possesses greater stability and will not tip over due to contact by the animal during feeding.

It is to be appreciated that the legs may be of varying lengths depending on the relative heights of the animals to be fed. In one embodiment, the legs 22, 24, 32, 34 are height-adjustable by way of height adjustment means 52, 54, 56, 58, which interrupt each leg 22, 24, 32, 34. The height adjustment means may consist of threaded interconnecting pieces, slidably secured telescoping pieces, or the like. The height adjustment means provide maximum flexibility for the feeding of all animals ranging in height from medium-sized dogs to horses.

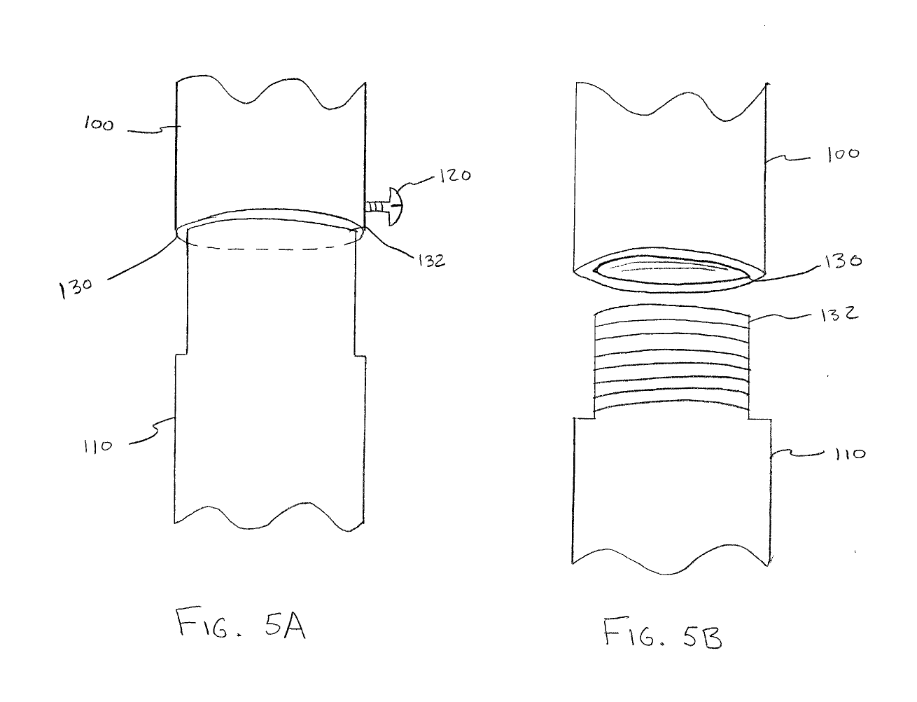

More particularly, with reference to FIG. 5A, each support leg includes an upper portion 100, a lower portion 110, and a setting means 120. In one embodiment, the upper portion 100 includes a first end (not shown) connected to the corresponding horizontal cross member and a second end 130 adapted to receive the lower portion 110. The lower portion 110 includes a first end 132 which is slidably attached to the second end 130 of the upper portion 100. The setting means 120, which is preferably a set screw, is operative for setting the support leg at a desired height. In an alternate embodiment, illustrated in FIG. 5B, the upper portion 100 and lower portion 110 each contain threaded ends 130, 132 which are threadably matable in a height-adjustable fashion.

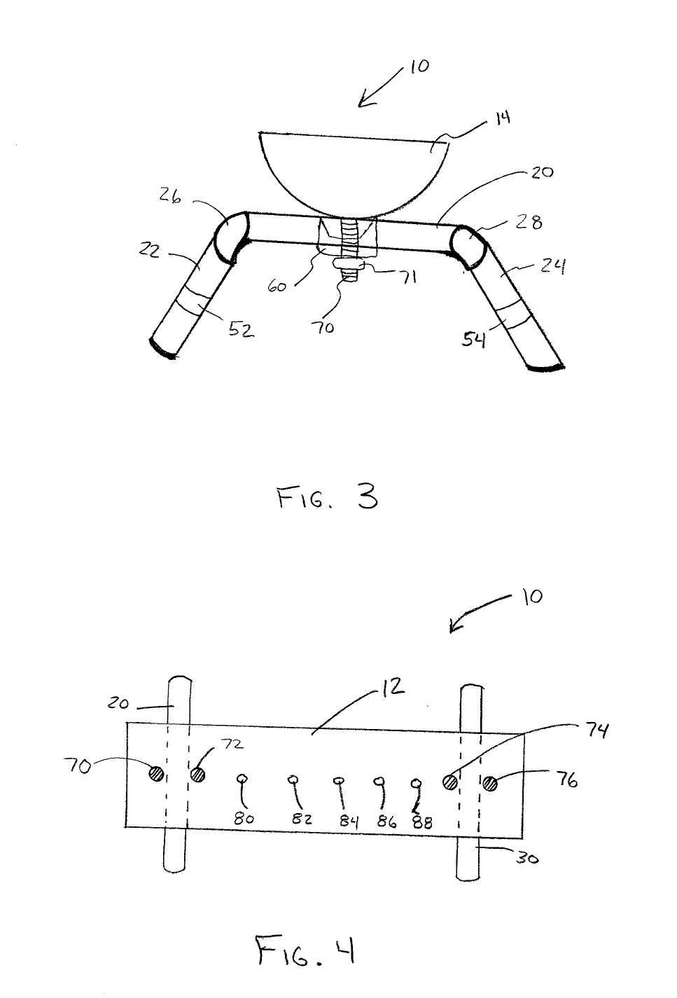

As illustrated in FIGS. 3-4, the horizontal cross members 20, 30 are attached to the feed trough 12 by appropriate fastening means. In one embodiment, each horizontal cross member 20, 30 is attached by a clamp 60, such as a muffler clamp, which is inverted such that it cradles the horizontal support member. More particularly, two carriage bolts 70, 72, extend through the bottom of the feed trough and through the clamp 60, as shown. Each carriage bolt is secured to the clamp with a nut and a washer 71. Preferably, the fastening means consist of non-oxidizing materials, such as stainless steel or aluminum, or are coated with a protective layer, such as lacquer or clear coat.

As illustrated in FIG. 4, the animal feeder includes a plurality of drainage apertures or holes 80, 82, 84, 86, 88 along the bottom of the feed trough 12 every four to six inches. In one embodiment the drainage holes are ¼ inch in diameter. It is to be appreciated that the drainage holes may be larger or smaller depending on the amount of drainage necessary. However, the diameter of the drainage holes must be less than the size of the feed within the feed trough in order to avoid feed leakage.

The invention has been described with reference to the preferred embodiment. Modifications and alterations will occur to others upon a reading and understanding of the preceding detailed description. It is intended that the invention be construed as including all such modifications and alterations insofar as they come within the scope of the appended claims or the equivalents thereof.

Having thus described the preferred embodiment, the invention is now claimed to be:

1. An animal feeder assembly comprising:
a semi-cylindrical feed trough having a pair of semi-circular end caps connected thereto;
a pair of horizontal cross members each connected to an underside of the feed trough adjacent the end caps, said cross members being disposed substantially perpendicular to the feed trough; and
a pair of height-adjustable support legs connected to opposing ends of each horizontal cross member such that the support legs form an angle of between 45° and 60° with a ground surface.

2. The animal feeder assembly according to claim 1, wherein the semi-cylindrical feed trough is made from a weather resistant material.

3. The animal feeder assembly according to claim 2, wherein the semi-cylindrical feed trough is made from polyvinyl chloride.

4. The animal feeder assembly according to claim 1, wherein the semi-cylindrical feed trough defines a plurality of regularly-spaced drainage apertures.

5. The animal feeder assembly according to claim 1, wherein each height-adjustable support leg includes an upper portion, a lower portion, and securing means for setting the support leg at a desired height;
wherein the upper portion includes:
a first end connected to the corresponding horizontal cross member; and
a second end adapted to receive the lower portion; and
wherein the lower portion includes:
a first end slidably attached to the second end of the upper portion; and
a second end adapted to engage the ground surface, said second end having an inclined surface at an angle which is complementary to the angle between 45° and 60°.

6. The animal feeder assembly according to claim 5, wherein the setting means includes a set screw.

7. The animal feeder assembly according to claim 1, wherein each height-adjustable support leg includes an upper portion and a lower portion threadably attached thereto;
wherein the upper portion includes:
a first end connected to the corresponding horizontal cross member; and
a second threaded end adapted to receive the lower portion; and
wherein the lower portion includes:
a first end threadably connected to the second end of the upper portion; and
a second end adapted to engage the ground surface.

8. The animal feeder assembly according to claim 7, wherein the second end of the lower portion includes an inclined surface at an angle which is complementary to the angle between the support leg and the ground surface.

9. The animal feeder assembly according to claim 1, wherein the horizontal cross members and the support legs are comprised of polyvinyl chloride (PVC) piping having a diameter between 1.5 inches and 2.0 inches.

10. The animal feeder assembly according to claim 9, wherein each support leg is connected to the corresponding horizontal cross member via a PVC elbow joint.

11. A wildlife feeder comprising:
a feed trough having a pair of end portions and a curved bottom surface which defines a plurality of drainage apertures; and
a pair of height-adjustable support structures connected to an underside of the curved feed trough adjacent each end portion.

12. The wildlife feeder according to claim 11, wherein the curved feed trough is comprised of a semi-cylindrical polyvinyl chloride (PVC) pipe having a diameter between 6 inches and 10 inches.

13. The wildlife feeder according to claim 12, wherein each height-adjustable support structure includes:
a horizontal member disposed substantially perpendicular to the feed trough;
a pair of height-adjustable support legs connected to opposing ends of the horizontal cross member, said support legs including:
an upper portion;
a lower portion; and
height adjustment means connecting the upper portion to the lower portion.

14. The wildlife feeder according to claim 13, wherein the height adjustment means includes a threaded piece connecting the upper and lower portions.

15. The wildlife feeder according to claim 13, wherein the height adjustment means includes:
an intermediate piece telescopically connected to at least one of the upper and lower portions; and
a set screw disposed adjacent the intermediate piece.

16. The wildlife feeder according to claim 13, wherein the support legs are disposed at an angle of between 45° and 60° relative to a ground surface.

17. The wildlife feeder according to claim 16, wherein each support leg includes a bottom surface having an angle of between 30° and 45°.

18. The wildlife feeder according to claim 17, wherein the horizontal cross members and support legs are comprised of PVC pipe having a diameter between 1.5 inches and 2.0 inches.
